(19) United States
(12) Patent Application Publication
(10) Pub. No.: US 2009/0120869 A1
(43) Pub. Date: May 14, 2009

(54) FUEL INJECTOR FILTER

(75) Inventors: Randall C. Harkema, Caledonia, MI (US); Josh Bennett, Lowell, MI (US); Derek Vander Weide, Grand Rapids, MI (US)

Correspondence Address: MCGARRY BAIR PC, 32 Market Ave. SW, SUITE 500, GRAND RAPIDS, MI, 49503, US

(73) Assignee: ROBERT BOSCH GMBH, Stuttgart (DE)

(21) Appl. No.: 11/718,136

(22) PCT Filed: Oct. 28, 2004
(86) PCT No.: PCT/US2004/035790

§ 371 Date: Nov. 18, 2008

Related U.S. Application Data
(63) Continuation-in-part of application No. PCT/US2004/035790, filed on Oct. 28, 2004.

(51) Int. Cl. B01D 29/07

(52) U.S. Cl. 210/498

(57) ABSTRACT

A filter (100, 200) is provided especially for high aspect ratio particles in a conduit (102, 202) for a fuel injection system. The filter (100, 200) can be an edge filter (100) or a sack filter (200) with an annular gap (116, 212) between the filter section (106, 206) and the conduit wall sized smaller than previously known in order to filter high aspect ratio particles without significant changes in pressure drop. The edge filter (100) relates the gap (116) to grooves (118) in the filter section (106), and the sack filter (200) relates the gap (212) to the size of the holes (210) in the filter section (206).

### BACKGROUND OF THE INVENTION

1. Field of the Invention

The present invention relates to filters for a common rail fuel system and more particularly, filters that are utilized in high pressure inlets to fuel injectors.

2. Description of the Related Art

Common rail fuel systems are well known for high pressure fuel injection in internal combustion engines. Pressures in common rail systems can range from 250 bar to 2200 bar (3,600 to 32,000 psi). Individual injectors are connected to the common rail by high pressure conduits. Common rail fuel systems utilize electronic controls to control the timing of the beginning of injection and the completion of injection. The timing of the injection cycle may be adjusted electronically. Maintaining close tolerances of the injector components in a high pressure environment is important because it maintains the accuracy of fuel injection events. Debris in the fuel flow can not only obstruct the nozzle and cause unacceptable injector performance, but over time, wear at the close tolerances of the injector components.

Filters are typically disposed upstream of the injectors to ensure that fuel delivered to the injector nozzles during an injection event is free of debris, insofar as possible. Debris in the fuel can be residue from manufacturing or machining in any upstream component such as a pump, a conduit, a valve, or the like. Debris can also include service debris accompanying the fuel itself and not previously filtered.

Edge filters are normally provided in the coupling between the injector and the fuel conduit or in an extension of the injector as the last component before fuel enters the injector. Edge filters not only block particles of predetermined size, but they also act as particle shredders in that they reduce the size of debris particles in the fuel to an acceptable size less likely to interfere with injection. An acceptable particle size for heavy duty applications in a high pressure system may be as large as 120 microns. Determination of an acceptable size is normally driven by the performance requirements of the injector.

A typical edge filter of the prior art can be seen in FIGS. 1 and 2. The edge filter 10 has an inlet end 12 and an outlet end 14. One or more inlet channels or flutes 16 extend longitudinally from the inlet end 12 and terminate before they reach the outlet end 14. Similarly, one or more outlet channels or flutes 18 adjacent to the inlet channels extend longitudinally from the outlet end 14 and terminate before they reach the inlet end 12. The inlet and outlet channels 16, 18 are separated from each other by ridges 20. When installed in a high pressure fuel conduit 21, the diameter of the edge filter 10 at the ridges 20 is less than the diameter of the conduit 21 in which it is disposed so that there an annular gap 23 between the ridges and the conduit. A typical gap will measure on the order of 20-50 microns, but the actual size is determined by performance requirements. The edge filter 10 is typically made of low carbon steel.

Fuel enters the inlet channels 16 and flows over the ridges 20 into the outlet channels 18 (see arrows). As it is forced through the gap 23, unacceptably large debris particles are blocked, shredded on the sharp edges of the ridges 20, or compressed in the gap 23 to an acceptable size before exiting the filter and continuing to the injector nozzle. In this high pressure environment, changing pressure waves, alternate stagnation and turbulence, and back flow eddies in the edge filter 10 enhance the shredding of particles and the flushing of the filter. A problem with known edge filters is that debris particles with high aspect ratios can still slip through and interfere with injection events. Such particles are found to be pancake shaped or rod shaped, so that at least one linear dimension of the particles exceeds an acceptable size. A solution is not to be found in simply making the gap smaller. Reducing the gap size may cause an unacceptable flow restriction, and may still not solve the problem of high aspect ratio particles.

Another kind of filter is commonly known as a sack filter, most often used in the pressure regulator of a common rail. A sack filter is cylindrically shaped, with one end open, the other end closed, and plurality of laser-drilled bores in the cylindrical wall. Fuel enters from the closed end, passes through the bores and exits through the open end, and the bores filter particles carried by the fuel.

There remains a need to improve the performance of high pressure fuel filters in common rail systems.

### SUMMARY OF THE INVENTION

A significant improvement is found in the present invention of a filter for fitting in a high pressure conduit of a fuel injection system of the type having a fuel injector, where a high pressure fuel conduit has a known inside diameter. An edge filter for fitting in a high pressure conduit of a fuel injection system comprising a fuel injector includes a filter section formed of inlet channels and outlet channels separated by ridges. The ridges have a predetermined diameter less than the conduit diameter, and the difference between the predetermined diameter and the conduit diameter defines an annular gap. In accord with the invention, annular grooves are disposed in at least one of the ridges. Preferably, the annular grooves are disposed in all of the ridges. Also, the filter section will typically have three ridges.

The annular grooves are preferably disposed within a density range of 12-26 grooves per mm and are within a range of 22-35 microns wide. The annular grooves are preferably within a range of 36-50 microns deep. The annular gap is preferably equal to or less than 22 microns. The width of each groove is equal to or greater than the annular gap. In any event, the annular gap and/or grooves are sized so that the highest operational flow rate of fuel through the edge filter will result in a pressure gradient of less than about 300 bar.

In another aspect of the invention, a sack filter for fitting in a high pressure conduit of a fuel injection system comprising a fuel injector includes a filter section having holes extending through a wall of the filter section. The filter section has a predetermined diameter less than the conduit diameter, and the difference between the predetermined diameter and the conduit diameter defines an annular gap. In accord with the invention, the annular gap is less than 10 times the average diameter of the holes.

The holes are preferably within a density range of 10-21 holes per mm² and each hole has a diameter of approximately 50 microns. In any event, the gap is sized so that the highest operational flow rate of fuel through the edge filter will result in a pressure gradient of less than about 300 bar or, preferably, 150 bar.

### BRIEF DESCRIPTION OF THE DRAWINGS

In the drawings:

FIG. 1 is a perspective view of an edge filter of the prior art.

FIG. 2 is a cross sectional view of a portion of the edge filter of FIG. 1 disposed in a high pressure fuel conduit.

FIG. 3 is a view, partly in cross section, of an edge filter according to the invention disposed in a high pressure fuel conduit.

FIG. 4 is an enlarged view of the area marked IV in FIG. 3

FIG. 5 is a view, partly in cross section, of a sack filter disposed in a high pressure fuel conduit according to the invention.

FIG. 6 is an enlarged view of the area marked VI in FIG. 5.

FIG. 7 is a perspective view, partly in cross section, of a high pressure fuel conduit with a second embodiment of a sack filter, according to the invention.

FIG. 8 is an end view of the installed sack filter of FIG. 7.

FIG. 9 is a cross sectional view of the sack filter of FIG. 8 taken along line 9-9.

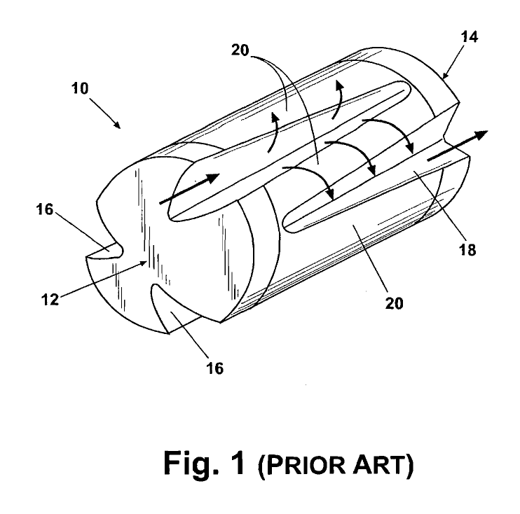

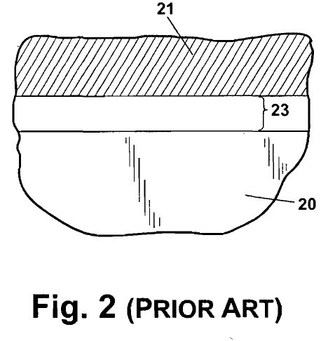

### DETAILED DESCRIPTION

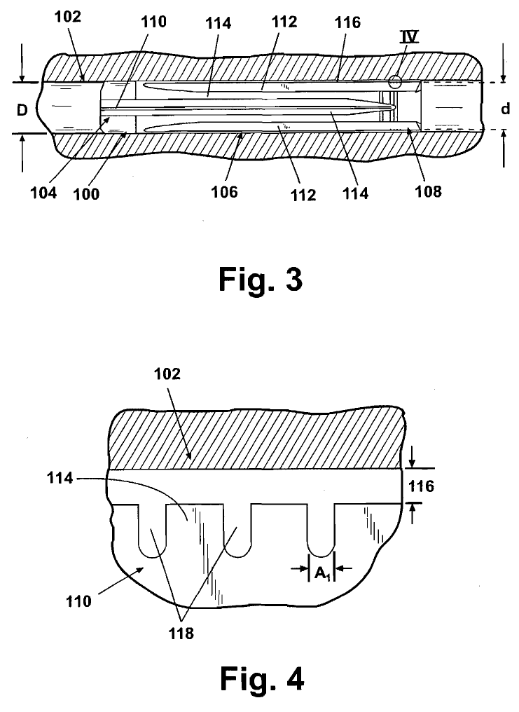

Looking first at FIGS. 3 and 4, a first embodiment of the invention is illustrated in an edge filter 100 adapted to be mounted in a high pressure conduit 102. The edge filter 100 has an inlet end 104, a filter section 106, and an outlet end 108. The filter section 106 extends between the inlet end 104 and the outlet end 108. A plurality of inlet channels 110 (equidistant from each other) extend longitudinally from the inlet end 104 and terminate before they reach the outlet end 108. As illustrated, three inlet channels 110 extend through the inlet end 104. Similarly, a plurality of outlet channels 112 interspersed between the inlet channels 110 extend longitudinally from the outlet end 108 and terminate before they reach the inlet end 104. The outlet channels 112 extend through the outlet end 108. Here, there are three outlet channels 110. The inlet and outlet channels 110, 112 are separated from each other by ridges 114 which are in the filter section 106.

The diameter D of the edge filter 100 at the inlet and outlet ends 104, 108 is the same as (or nominally larger than) the inside diameter of the high pressure conduit 102. Thus, the edge filter 100 can be press fit into the conduit 102 and held in place by friction of the outer surfaces of the inlet and outlet ends 104, 108 bearing against the inside surface of the conduit 102. In other words, the inlet and outlet ends 104, 108 serve as securing sections to hold the edge filter 100 in place within the high pressure conduit 102. The diameter d of filter section 106, i.e., the edge filter 100 at the ridges 114, is less than the diameter D, so that there is an annular gap 116 between the ridges 114 and the inside surface of the conduit 102.

Between the inlet and outlet ends 104, 108 is a plurality of annular grooves 118 on the ridges 114. With the additional area between adjacent inlet and outlet channels 110, 112 afforded by the grooves 118, the annular gap 116 can be smaller than known in the prior art without further restricting flow. The annular gap 116 is sized to provide a secondary filtration in addition to the ridges 114 so that preferably, particles equal to or greater than about 120 microns in any dimension will be effectively shredded or deformed so as to prevent interference with an injection event at the fuel injector. An acceptable pressure drop is typically less than about 300 bar at the highest operational flow rate, which can be maintained with a smaller annular gap, according to the invention. Where a typical gap in the prior art might measure on the order of 20-50 microns, the annular gap 116 can be less than 20 microns in the invention. In such case, the distance between adjacent grooves 118 may be on the order of 80 microns. Preferably the width A₁ of each groove 118 will be in a range of 22-35 microns, and the depth 122 of each groove 118 will be in a range of 36-50 microns. The density of the grooves 118 on the ridges 114 is preferably in a range of 12-26 grooves per mm. The width of each groove 118 is preferably greater than or equal to the annular gap 116. The edge filter 100 is typically made of low carbon steel.

In operation, fuel at high pressure enters the inlet channels 110, flows over the ridges 114 and through the grooves 118 into the outlet channels 112. Debris particles, and especially high aspect ratio debris particles that are carried in the fuel, are presented with sharp edges at the ridges 114, both at the top of the ridges 114 and at the sides and bottom of the grooves 118. They are also presented with smaller openings in both the annular gap 116 and grooves 118 through which to pass. Consequently, there is a higher probability of such particles being shredded or reduced to an acceptable size by the edge filter 100. Moreover, this improved performance is achieved with no more flow restriction than exists in the prior art.

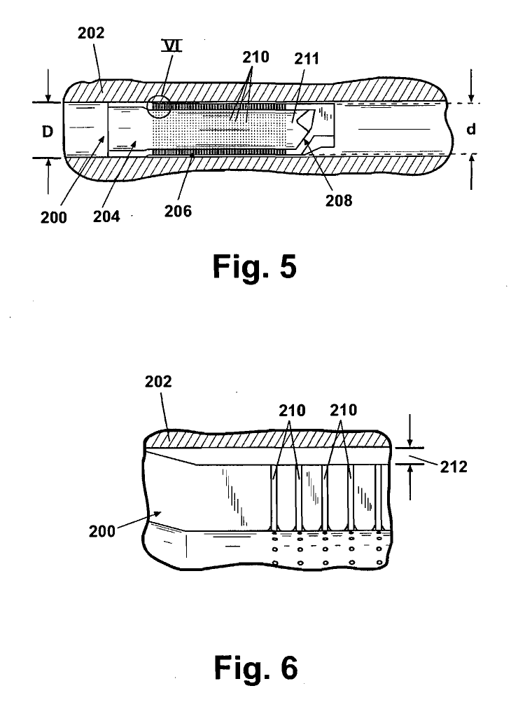

Looking now at FIGS. 5 and 6, a second embodiment of the invention is illustrated in a sack filter 200 mounted in a high pressure conduit 202. The sack filter 200 is formed from a cylinder having an inlet section 204, a filter section 206, and an end section 208. The inlet section 204 has a diameter D larger than the diameter d of the filter section 206. The filter section 206 comprises a plurality of holes 210 extending through the wall, preferably laser drilled in a range of approximately 10-21 holes/mm². Each hole has a diameter of about 50 microns. The material is preferably stainless steel. The end section 208 is closed by crimping to create a blind sack 211, preferably closed in that it has no holes to provide an exit. The blind sack 211 is that volume of the sack filter more than about 1 mm beyond the last hole 210 downstream from the inlet section 204.

The diameter D of the inlet section 204 is the same as (or nominally larger than) the inside diameter of the high pressure conduit 202. Thus, the sack filter 200 can be press fit into the conduit 202 and held in place by friction of the outer surface of the inlet section 204 bearing against the inside surface of the conduit 202. In other words, the inlet section 204 serves as a securing section to hold the sack filter 200 in place within the high pressure conduit 202. Since the diameter d of the filter section 206 is less than the diameter D, there is an annular gap 212 between the filter section 206 and the inside surface of the conduit 202. According to the invention, the annular gap 212 is set to be less than 10 times the diameter of a single hole 210, but not so much less that the pressure drop across the filter is unacceptable. An acceptable pressure drop is about 150 bar at the highest operational flow rate. An acceptable target flow rate is 600 liters/hr. at 100 bar. It will be understood that these values are exemplary only, and that actual values can be higher or lower depending upon performance requirements.

In operation, fuel at high pressure enters the inlet section 204 and is forced through the holes 210 and into the gap 212. Debris particles carried by the fuel that are larger than the holes 210 are arrested at the entrance to the holes in the filter 202. Debris particles of a high aspect ratio such as those of a long needle shape may pass through the holes 210, but they will be arrested or deformed to an acceptable size in the narrow gap 212. It has been found that debris that is arrested at the holes 210 is eventually captured in the blind sack 211 so that the holes can remain unplugged.

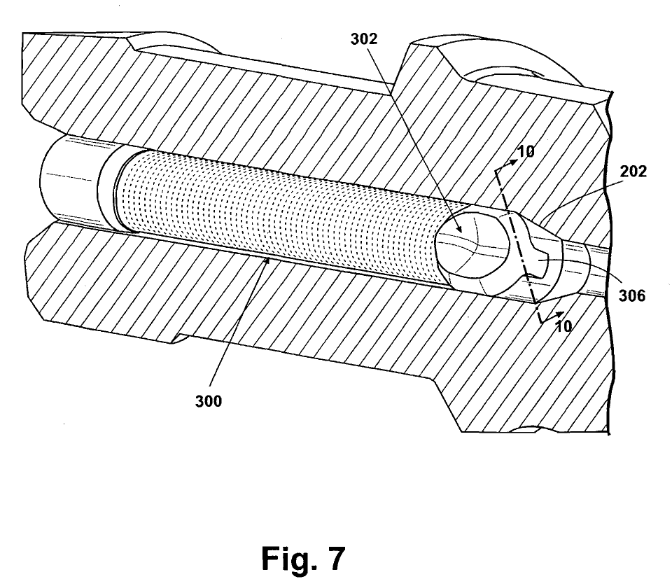

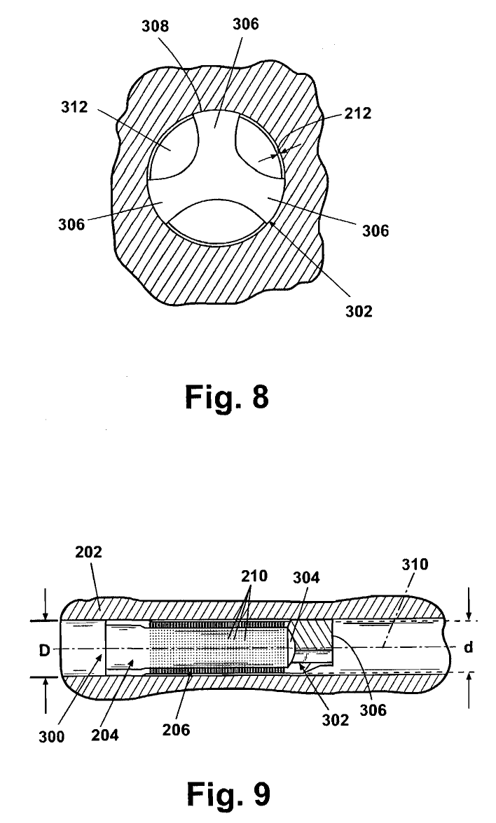

Looking now at FIGS. 7-9, another embodiment of a sack filter 300 is illustrated. The sack filter 300 is in all respects identical to the sack filter 200 of FIGS. 6 and 7, except for the end section 302, and consequently, like components will have like numerals. The end section 302 is closed to create a blind sack 304 in that it has no holes to provide an exit. The blind sack 304 is that volume of the sack filter more than about 1 mm beyond the last hole 210 downstream from the inlet section 204. Internally, the blind sack 304 functions identically to the blind sack 211 illustrated in FIGS. 6 and 7. It has been found advisable to ensure that the sack filter 302 remains centered within the high pressure conduit 202. If so, then the annular gap 212 will maintain its dimension relative to the holes 210 around the entire filter section 206. To maintain this centering, a plurality of lobes 306, preferably three, is formed in outer wall of the end section 302. Each lobe 306 has a peripheral surface 308 that has a radius centered on the longitudinal axis 310 of the sack filter 300 substantially identical to the radius of the high pressure conduit 202. Preferably, the tolerances are such that the lobes 306 will just touch the inside surface of the high pressure conduit 202, but not so tightly as to make it difficult to insert the sack filter into the conduit. It will be understood that the inlet section preferably retains the sack filter 300 within the conduit 202 by friction. The lobes 306 need only maintain the sack filter centered within the conduit.

Also, preferably, the width of each lobe 306 will be sized so that the gaps 312 between them will define a cross sectional area equal to or greater than the cross sectional area of the annular gap 212. In other words, the lobes 306 must be sized so as to not obstruct or limit the flow of fuel. The sack filter 300 can be formed by deep drawing the material, and then crimping the end section 302 to form the lobes 306.

While the invention has been specifically described in connection with certain specific embodiments thereof, it is to be understood that this is by way of illustration and not of limitation, and the scope of the appended claims should be construed as broadly as the prior art will permit.

What is claimed is:

1. An edge filter (100) for fitting in a high pressure conduit (102) of a fuel injection system comprising a fuel injector, wherein the high pressure conduit (102) has a conduit diameter, the edge filter (100) comprising a filter section (106) formed of inlet channels (110) and outlet channels (112) separated by ridges (114), the ridges (114) having a predetermined diameter less than the conduit diameter, the difference between the predetermined diameter and the conduit diameter defining an annular gap (116) and at least one of the ridges (114) having annular grooves (118), characterized by
the width of each groove (118) being equal to or greater than the annular gap (116) and less than the depth of each groove (118).

2. The edge filter (100) of claim 1 wherein the filter section (106) has three ridges (114).

3. The edge filter (100) of claim 1 wherein the annular grooves (118) are disposed within a density range of 12-26 grooves per mm.

4. The edge filter (100) of claim 1 wherein the annular grooves (118) are within a range of 22-35 microns wide.

5. The edge filter (100) of claim 1 wherein the annular grooves (118) are within a range of 36-50 microns deep.

6. The edge filter (100) of claim 1 wherein the annular gap (116) is equal to or less than 22 microns.

7. The edge filter (100) of claim 1 wherein the annular gap (116) and the annular grooves (118) are sized so that the highest operational flow rate of fuel through the edge filter when installed in the conduit of a fuel injector will result in a pressure gradient of less than about 300 bar.

8. A sack filter (200, 300) for fitting in a high pressure conduit (202) of a fuel injection system comprising a fuel injector, wherein the high pressure conduit (202) has a conduit diameter, the sack filter (200) comprising a filter section (206) having holes (210) extending through a wall of the filter section, the filter section (206) having a predetermined diameter less than the conduit diameter, the difference between the predetermined diameter and the conduit diameter defining an annular gap (212), characterized by
the annular gap (212) being less than 10 times the average diameter of the holes (210).

9. The sack filter (200, 300) of claim 8 wherein the holes (210) are within a density range of 10-21 holes per mm².

10. The sack filter (200, 300) of claim 8 wherein each hole (210) has a diameter of approximately 50 microns.

11. The sack filter (200, 300) of claim 8 wherein the pressure drop across the sack filter (200, 300) is less than about 300 bar.

12. The sack filter (200, 300) of claim 8 wherein the pressure drop across the sack filter (200, 300) is less than about 150 bar.

13. The sack filter (200, 300) of claim 8 further comprising an end section (208, 302) that defines a blind sack (211, 304), whereby debris particles obstructed by the holes (210) are retained.

14. The sack filter (200, 300) of claim 8 further comprising a plurality of lobes (306) centered on the longitudinal axis (310) of the sack filter to maintain the sack filter centered within the high pressure conduit (202).

15. The edge filter (100) of claim 2 wherein the annular grooves (118) are disposed within a density range of 12-26 grooves per mm.

16. The edge filter (100) of claim 15 wherein the annular grooves (118) are within a range of 22-35 microns wide.

17. The edge filter (100) of claim 16 wherein the annular grooves (118) are within a range of 36-50 microns deep.

18. The edge filter (100) of claim 17 wherein the annular gap (116) is equal to or less than 22 microns.

19. The sack filter (200, 300) of claim 8 wherein each hole (210) has a diameter of approximately 50 microns.

20. The sack filter (200, 300) of claim 19 wherein the pressure drop across the sack filter (200, 300) is less than about 300 bar.

21. The sack filter (200, 300) of claim 20 further comprising an end section (208, 302) that defines a blind sack (211, 304), whereby debris particles obstructed by the holes (210) are retained.

22. The sack filter (200, 300) of claim 21 further comprising a plurality of lobes (306) centered on the longitudinal axis (310) of the sack filter to maintain the sack filter centered within the high pressure conduit (202).
